(19) United States
(12) Patent Application Publication
(10) Pub. No.: US 2009/0219494 A1
(43) Pub. Date: Sep. 3, 2009

(54) EVALUATION METHOD, EVALUATION APPARATUS, AND EXPOSURE APPARATUS

(75) Inventor: Osamu Kakuchi, Kasama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/392,746

(22) Filed: Feb. 25, 2009

(30) Foreign Application Priority Data
Mar. 3, 2008 (JP) 2008-052581

(51) Int. Cl. G03B 27/00; G01B 11/03; G01B 9/02; G06F 15/00

(52) U.S. Cl. 355/18; 356/496; 702/150

(57) ABSTRACT

An evaluation method of evaluating an optical characteristic of an optical system to be evaluated using an interferometer, comprises a first acquisition step of acquiring a first interference fringe formed by the interferometer when a location of a movable element of the interferometer in an optical axis direction of the optical system is a first location, a second acquisition step of acquiring a second interference fringe formed by the interferometer when the location of the movable element in the optical axis direction is a second location different from the first location, a determination step of determining a pupil-center coordinate of the optical system based on the acquired first interference fringe and the acquired second interference fringe, and a computation step of computing the optical characteristic of the optical system using the pupil-center coordinate determined in the determination step.

### BACKGROUND OF THE INVENTION

1. Field of the Invention

The present invention relates to an evaluation method and evaluation apparatus which evaluate the optical characteristic of an optical system to be evaluated using an interferometer, and an exposure apparatus having the evaluation apparatus.

2. Description of the Related Art

In recent years, a projection optical system mounted in an exposure apparatus is being required to have a performance high enough to suppress its transmitted wavefront aberration below 10 mλ RMS (λ=248 nm, 193 nm, and so on). To keep up with this trend, it is being demanded to measure the wavefront aberration with an accuracy as high as about 1 mλ. Conventionally, it is a common practice to measure the wavefront aberration of the projection optical system at each of a plurality of points in the field using an interferometer. Phase scanning (shift) interferometers as disclosed in Japanese Patent Laid-Open Nos. 2004-245744 and 9-96589 are often used to adjust the projection optical system. Nowadays, the exposure apparatus can measure the wavefront aberration, as disclosed in Japanese Patent Laid-Open No. 2000-277412.

The wavefront aberration is an index representing the imaging performance of the projection optical system and can be interpreted as the optical characteristic on the pupil plane. Separately from this optical characteristic, optical characteristics associated with the image position (image plane and image distortion) can be evaluated based on the position information of an interferometric optical system upon interferometric measurement for an off-axis wavefront aberration, as disclosed in Japanese Patent Laid-Open No. 9-96589.

A Zernike polynomial is often used to represent the two-dimensional phase distribution obtained by the interferometric measurement as the wavefront aberration. To accurately calculate the coefficient of the Zernike polynomial, it is necessary to precisely calculate the center coordinate of an interference fringe (two-dimensional phase distribution). It is a common practice to determine the center coordinate by detecting the edge of the measured interference fringe or the intensity distribution of the test light beam.

Japanese Patent Laid-Open No. 2006-324311 determines the pupil-center coordinate by calculating a pupil-center coordinate at which a change in the on-axis coma aberration upon changing the object distance is minimum.

An example of the optical characteristics of the projection optical system, other than the wavefront aberration and image position, is the telecentricity representing the tilt of a light beam on the object or image side. Japanese Patent Laid-Open No. 10-170399 proposes a method which uses a test reticle to measure the telecentricity. This method arranges a test reticle having a reference pattern in an exposure apparatus, and transfers patterns corresponding to a plurality of (two or more) focus positions upon moving the wafer stage in the optical axis direction onto the wafer. Based on a change in the image position at this time, the tilt (telecentricity) of a light beam on the wafer side can be calculated. A change in the image position is determined by measuring the positions of the transferred patterns by, for example, a coordinate measuring device.

The above-mentioned prior arts pose the following problems.

In the edge detection method which determines the center coordinate in wavefront aberration measurement, it is difficult to accurately detect the center coordinate and, therefore, to accurately measure the wavefront aberration.

Although the method disclosed in Japanese Patent Laid-Open No. 9-96589 determines the pupil-center coordinate by calculating a pupil-center coordinate at which a change in the on-axis coma aberration upon changing the object distance is minimum, it cannot precisely determine the pupil-center coordinate for an off-axis wavefront aberration.

Japanese Patent Laid-Open No. 10-170399 which discloses a technique concerning the telecentricity measures by a coordinate measuring device the image position of a pattern transferred onto the wafer using a test reticle, so it involves a large number of processes to obtain the measurement result, and requires a long measurement time.

### SUMMARY OF THE INVENTION

The present invention has been made in consideration of the above-described problems, and has as its object to more easily and accurately evaluate, for example, the optical characteristic of an optical system to be evaluated.

According to the first aspect of the present invention, there is provided an evaluation method of evaluating an optical characteristic of an optical system to be evaluated using an interferometer, the method comprising a first acquisition step of acquiring a first interference fringe formed by the interferometer when a location of a movable element of the interferometer in an optical axis direction of the optical system is a first location, a second acquisition step of acquiring a second interference fringe formed by the interferometer when the location of the movable element in the optical axis direction is a second location different from the first location, a determination step of determining a pupil-center coordinate of the optical system based on the acquired first interference fringe and the acquired second interference fringe, and a computation step of computing the optical characteristic of the optical system using the pupil-center coordinate determined in the determination step.

According to the second aspect of the present invention, there is provided an evaluation apparatus which evaluates an optical characteristic of an optical system to be evaluated using an interferometer, the apparatus comprising an image sensor which senses an interference fringe formed by the interferometer, and a computing unit which computes the optical characteristic of the optical system based on the image of the interference fringe provided by the image sensor, wherein the computing unit determines a pupil-center coordinate of the optical system based on an image obtained by sensing by the image sensor a first interference fringe formed by the interferometer when a location of a movable element of the interferometer in an optical axis direction of the optical system is a first location, and an image obtained by sensing by the image sensor a second interference fringe formed by the interferometer when the location of the movable element in the optical axis direction is a second location different from the first location, and computes the optical characteristic of the optical system using the determined pupil-center coordinate.

According to the third aspect of the present invention, there is provided an exposure apparatus which projects a pattern of an original onto a substrate by a projection optical system, thereby exposing the substrate, the apparatus comprising an evaluation apparatus which evaluates an optical characteristic of the projection optical system using an interferometer, the evaluation apparatus including an image sensor which senses an interference fringe formed by the interferometer, and a computing unit which computes the optical characteristic of the projection optical system based on the image of the interference fringe provided by the image sensor, wherein the computing unit determines a pupil-center coordinate of the projection optical system based on an image obtained by sensing by the image sensor a first interference fringe formed by the interferometer when a location of a movable element of the interferometer in an optical axis direction of the projection optical system is a first location, and an image obtained by sensing by the image sensor a second interference fringe formed by the interferometer when the location of the movable element in the optical axis direction is a second location different from the first location, and computes the optical characteristic of the projection optical system using the determined pupil-center coordinate.

Further features of the present invention will become apparent from the following description of exemplary embodiments with reference to the attached drawings.

### BRIEF DESCRIPTION OF THE DRAWINGS

FIG. 1 is a view showing the schematic arrangement of an exposure apparatus according to a preferred embodiment of the present invention;

FIG. 2 is a view showing an example of the detailed arrangement of a reference wavefront generating optical system;

FIG. 3 is a view showing an example of the detailed arrangement of a wavefront detecting unit;

FIG. 4 is a view illustrating the location of a movable element of an interferometer;

FIGS. 5A to 5D are views illustrating the wavefront aberrations (interference fringes);

FIGS. 6A and 6B are views each illustrating the location of a movable element of an interferometer;

FIGS. 7A to 7D are views illustrating the wavefront aberrations (interference fringes);

FIGS. 8A and 8B are views each illustrating the location of a movable element of an interferometer;

FIG. 9 is a view illustrating a light intensity distribution formed by light transmitted through a window in a reference wavefront generating optical system;

FIG. 10 is a view showing the schematic arrangement of an exposure apparatus according to a preferred embodiment of the present invention;

FIG. 11 is an enlarged view of the vicinity of the reticle plane;

FIG. 12 is a view illustrating the location of a movable element of an interferometer;

FIGS. 13A and 13B are views each illustrating the location of a movable element of an interferometer;

FIGS. 14A and 14B are views each illustrating the location of a movable element of an interferometer;

FIG. 15 is a graph showing the relationship between the pupil-center coordinate (origin coordinate) and the wavefront aberration computed based on it;

FIG. 16 is a flowchart illustrating a sequence of determining the pupil-center coordinate (origin coordinate); and

FIG. 17 is a flowchart illustrating a sequence of determining the pupil-center coordinate (origin coordinate).

### DESCRIPTION OF THE EMBODIMENTS

Preferred embodiments of the present invention will be described below with reference to the accompanying drawings.

### First Embodiment

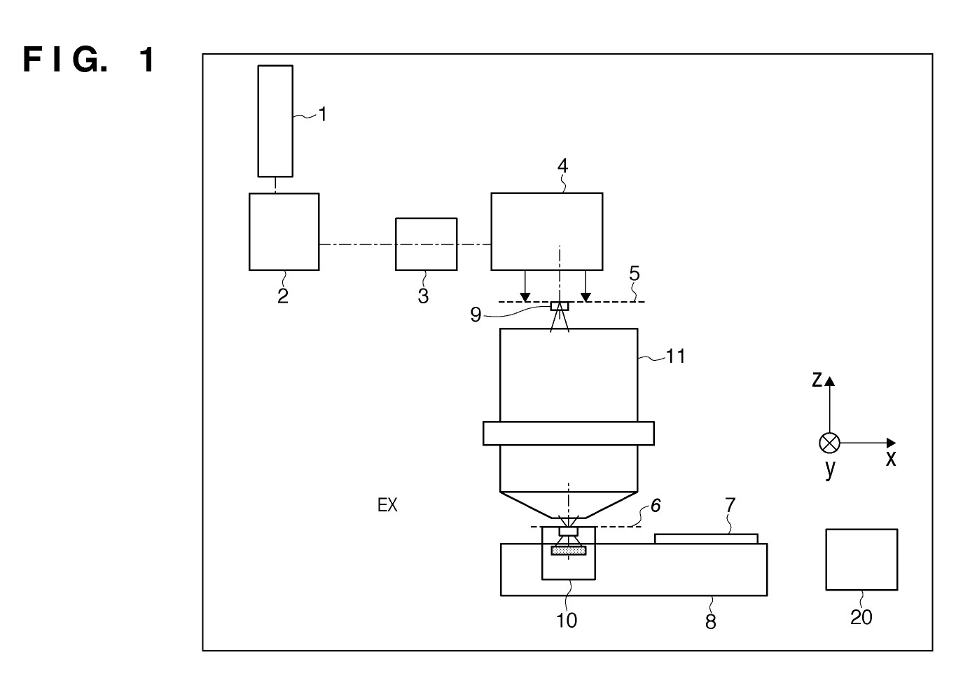

FIG. 1 is a view showing the schematic arrangement of an exposure apparatus according to a preferred embodiment of the present invention. An exposure apparatus EX according to this embodiment includes a projection optical system 11 for projecting the pattern of a reticle (original) inserted on a reticle plane 5 onto a wafer (substrate) 7. The exposure apparatus EX also includes an evaluation apparatus for evaluating the optical characteristic of the projection optical system 11 as an optical system to be evaluated. Light emitted by a light source 1 such as an excimer laser is guided to an incoherent unit 3 by a light extension optical system 2. The incoherent unit 3 lowers the coherency of the light and provides it to an illumination optical system 4. In exposing the wafer 7, the illumination optical system 4 illuminates the reticle inserted on the reticle plane 5. In evaluating the optical characteristic of the projection optical system 11, a reference wavefront generating optical system 9 is located on the reticle plane 5 and illuminated by the illumination optical system 4. The reference wavefront generating optical system 9 is typically located on a reticle stage (not shown) which holds the reticle, and can move in a direction along the object plane of the projection optical system 11 (reticle plane 5) and a direction along its optical axis. A wavefront detecting unit 10 is located on a wafer stage 8, which holds the wafer 7, beside a position to hold the wafer 7.

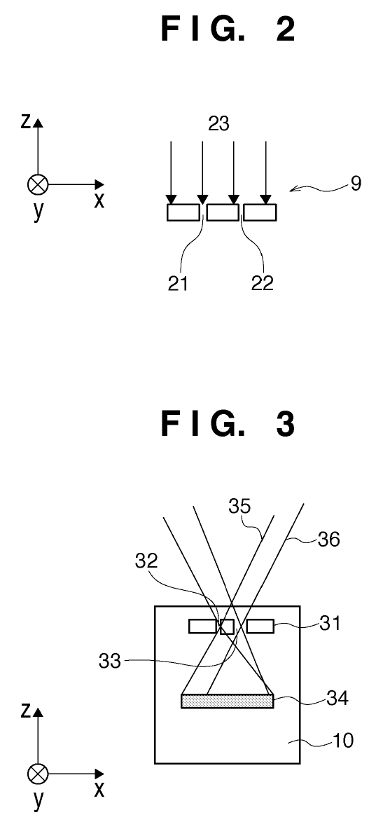

FIG. 2 is a view showing an example of the detailed arrangement of the reference wavefront generating optical system 9. The entire reference wavefront generating optical system 9 is illuminated with a light beam 23 from the illumination optical system 4. The reference wavefront generating optical system 9 includes a slit 22 having a width about ½ the wavelength of the incident light beam 23 (the wavelength of light emitted by the light source 1). Referring to FIG. 2, the y and x direction are the longitudinal and widthwise directions, respectively, of the slit 22. A pinhole may be used instead as long as the light beam 23 ensures a sufficient brightness. However, a slit is preferably used to increase the amount of light if an arrangement which illuminates the reticle plane 5 with light to expose the wafer is adopted. A window 21 having a short side longer than that of the slit 22 is formed in the reference wavefront generating optical system 9 to be adjacent to the slit 22.

FIG. 3 is a view showing an example of the detailed arrangement of the wavefront detecting unit 10. A second reference wavefront generating optical system 31 having an arrangement similar to that of the reference wavefront generating optical system 9 is located on a wafer plane 6 nearly flush with the surface of the wafer 7 held by the wafer stage 8. The second reference wavefront generating optical system 31 has a slit 32 and window 33 similar to the slit 22 and window 21 in the reference wavefront generating optical system 9. However, the short and long sides of the slit 32 and window 33 are reduced from those of the slit 22 and window 21 at the imaging magnification of the projection optical system 11.

A test light beam 36 from the slit 22 in the reference wavefront generating optical system 9 is transmitted through the window 33 in the second reference wavefront generating optical system 31. A reference light beam 35 from the window 21 in the reference wavefront generating optical system 9 is transmitted through the slit 32 in the second reference wavefront generating optical system 31. The test light beam 36 and reference light beam 35 form an interference fringe on the sensing surface of an image sensor 34 such as a CCD sensor. The wavefront aberration coefficient can be computed by processing the image of the interference fringe, which is sensed by the image sensor 34, in accordance with a known method to reproduce phase information, and fitting it to, for example, a Zernike function. Note that it is necessary to accurately calculate the wavefront aberration coefficient (for example, a Zernike coefficient) by precisely determining a pupil-center coordinate (origin coordinate) used in computation.

A method of determining the above-mentioned pupil-center coordinate will be exemplified herein. An evaluation method and evaluation apparatus according to this embodiment change the aberration by changing the object distance, measure the wavefront aberrations before and after the change, and calculate a pupil-center coordinate at which the amount of change in the wavefront aberration is a predetermined amount.

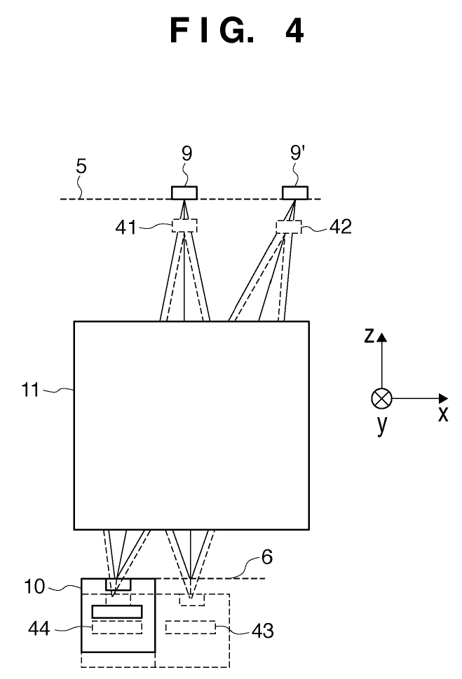

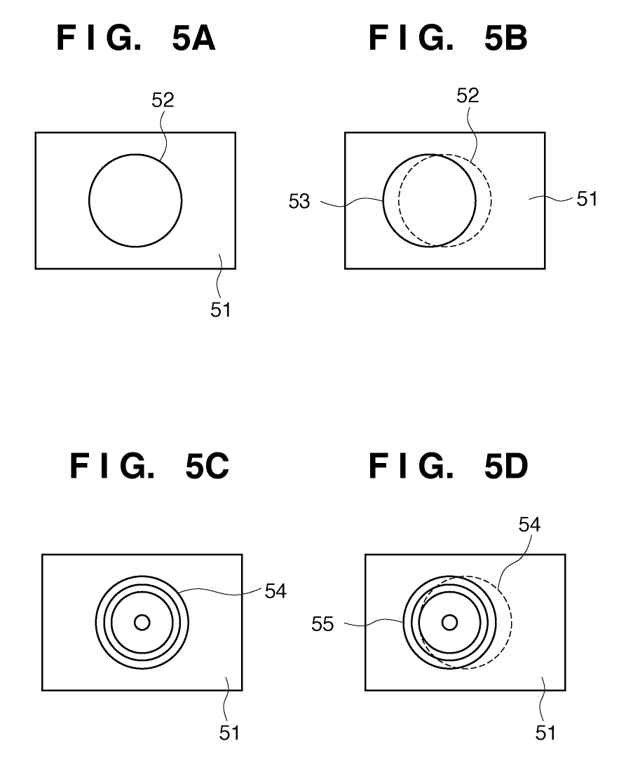

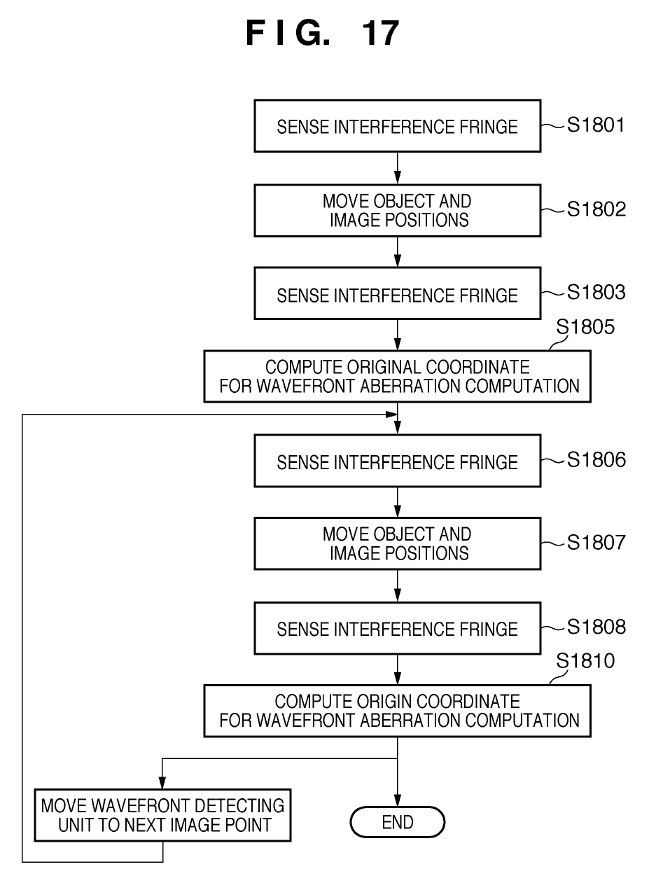

This method will be explained in detail with reference to FIGS. 4, 5A to 5D, and 17. The processing shown in FIG. 17 is controlled by a computing unit 20 shown in FIG. 1. A sequence of determining the pupil-center coordinate to compute the on-axis wavefront aberration of the projection optical system 11 as an optical system to be evaluated will be explained first. The reference wavefront generating optical system (first movable element) 9 and wavefront detecting unit (second movable element) 10 are located at on-axis positions flush with the reticle plane 5 and wafer plane 6, respectively. This location is defined as a first location, and the position of the wavefront detecting unit 10 in the first location is defined as a first position. In the first location, the image sensor 34 of the wavefront detecting unit 10 acquires an interference fringe by performing the first sensing of the interference fringe (step 1801 (first acquisition step)). For example, if the adjustment state of the projection optical system 11 is satisfactory, an almost one-color interference fringe (first interference fringe) 52 is formed on a sensing surface 51 of the image sensor 34 of the wavefront detecting unit 10, as shown in FIG. 5A, and is sensed by the image sensor 34.

The reference wavefront generating optical system 9 is driven in the optical axis direction of the projection optical system 11 to be located at a position 41 shown in FIG. 4. Also, the wafer stage 8 is driven to locate the wavefront detecting unit 10 at the conjugate position of the position 41 (step 1802). This location is defined as a second location, and the position of the wavefront detecting unit 10 in the second location is defined as a second position. While the object distance is changed in this way, the image sensor 34 of the wavefront detecting unit 10 acquires an interference fringe by performing the second sensing of the interference fringe (step 1803 (second acquisition step)). The projection optical system 11 generates a spherical aberration in response to a change in the object distance. An interference fringe (second interference fringe) 54 sensed by the image sensor 34 has an annular shape representing the characteristic of a low-order spherical aberration, as shown in FIG. 5C.

The computing unit 20 calculates a pupil-center coordinate (origin coordinate) for on-axis wavefront aberration computation (step 1805). A principle and method of calculating the pupil-center coordinate (origin coordinate) are as follows.

When attention is paid to the amount of change in the wavefront aberration of the projection optical system 11 between the first location and the second location, no coma aberration is generated in response to a change in the object distance because the reference wavefront generating optical system 9 and wavefront detecting unit 10 are located at on-axis positions of the projection optical system 11. Therefore, a pupil-center coordinate (origin coordinate) used in wavefront aberration computation must be a coordinate at which the amount of change in the coma aberration in response to a change in the object distance is minimum.

This logic will be explained with reference to drawings and equations. When an error of ΔX is generated in the origin coordinate upon computing an amount of change in the aberration measurement value (ΔW=W2−W1), an amount of error δ(ΔW) in the wavefront aberration computation result is given by:

δ(ΔW)=d(ΔW)/dx×ΔX

Note that the lowest-order (in this case, the fourth-order) aberration accounts for the amount of generation of a spherical aberration in response to a change in the object distance. Assume that the amount of change ΔW is:

ΔW=a·X⁴

where a is the aberration amount in the outermost pupil periphery and X is the pupil coordinate.

Then, we have:

δ(ΔW)=4·a·X³ΔX=(4·a·ΔX)·X³

The above-mentioned equation represents the third-order coma aberration which takes a value of (4·a·ΔX) in the outermost pupil periphery.

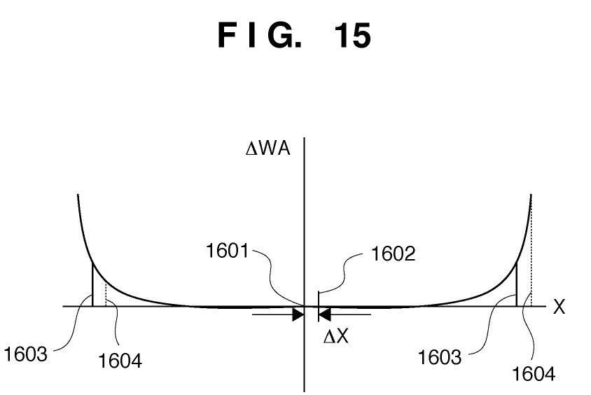

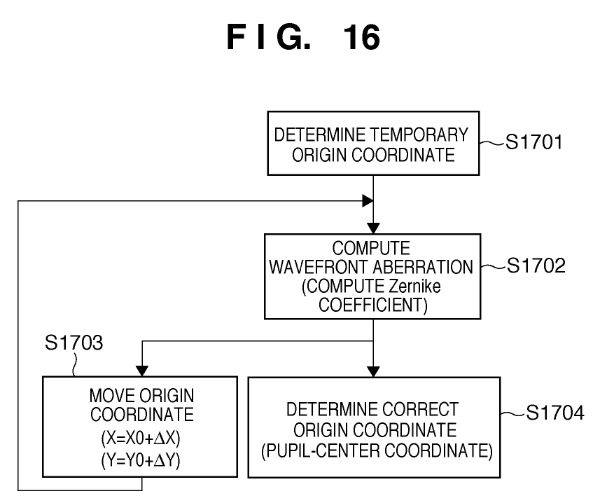

As can be understood from the above description, if the pupil-center coordinate (origin coordinate) used in wavefront aberration computation has an error, it translates into a coma aberration. The same logic will be explained with reference to FIG. 15. Referring to FIG. 15, if the origin coordinate is correct ((origin coordinate)=1601), the left and right positions of the outermost pupil periphery are 1603, and a bilaterally symmetrical aberration (spherical aberration) is obtained by computation. If the origin coordinate has an error ((origin coordinate)=1602), the left and right positions of the outermost pupil periphery are 1604, and a bilaterally asymmetrical aberration is measured. In other words, a coma aberration appears in the wavefront aberration computation result.

A correct origin coordinate can be calculated in the following way. An origin coordinate used in computing the wavefront aberration (for example, a Zernike coefficient) is changed, and the amount of change in the coma aberration in response to a change in the object distance is calculated at each of a plurality of origin coordinates. A precise origin coordinate can be determined by detecting an origin coordinate at which the calculated amount of change is minimum.

FIG. 16 is a flowchart illustrating a sequence of determining the pupil-center coordinate (origin coordinate). First, in step 1701, an origin coordinate (X0, Y0) used for the initial computation of the wavefront aberration coefficient (for example, a Zernike coefficient) is determined. An approximate center need only be calculated by, for example, fitting the outer periphery of a region including valid data of the measured wavefront aberration to a circle. In step 1702, the wavefront aberration (a first wavefront aberration, typically a coma aberration) before a change in the object distance, and that (a second wavefront aberration, typically a coma aberration) after the change in the object distance are computed using the origin coordinate determined in step 1701. In step 1703, the initial origin coordinate (X0, Y0) or the previous origin coordinate is changed to a different coordinate (X0+ΔX, Y0+ΔY). In step 1702, the wavefront aberration (a first wavefront aberration, typically a coma aberration) before a change in the object distance, and that (a second wavefront aberration, typically a coma aberration) after the change in the object distance are computed again. Steps 1702 and 1703 are repeated by incrementing the X and Y coordinates by the amounts of changes ΔX and ΔY which fall within Δxmax and Δymax, respectively. After this repetition is completed, an origin coordinate (XCMmin, YCMmin) at which the amount of change in the wavefront aberration (typically, a coma aberration) in response to a change in the object distance (the difference between the first wavefront aberration and the second wavefront aberration) is minimum (for example, zero) is calculated in step 1704. The origin coordinate at which the amount of change in the wavefront aberration (typically, a coma aberration) is minimum is a correct origin coordinate (pupil-center coordinate).

A pupil-center coordinate (origin coordinate) used to compute the off-axis wavefront aberration of the projection optical system 11 is determined. Referring to FIG. 4, the reference wavefront generating optical system 9 is located at a given off-axis position 9′, and a wavefront detecting unit 43 is located at its conjugate point. This location is defined as a third location, and the position of the wavefront detecting unit 10 in the third location is defined as a third position. In the third location, the image sensor 34 of the wavefront detecting unit 10 performs the third sensing of an interference fringe (step 1806). At this time, an almost one-color interference fringe 53 is formed on the sensing surface 51 of the image sensor 34, as shown in FIG. 5B. The interference fringe 53 can be formed at an on-axis position different from that of the interference fringe 52. This is because the telecentricity of the projection optical system 11 on its wafer side is imperfect.

The reference wavefront generating optical system 9 is moved in the optical axis direction of the projection optical system 11 to be located at a position 42, and the wavefront detecting unit 43 is located at its conjugate position (step 1807). This location is defined as a fourth location, and the position of the wavefront detecting unit 10 in the fourth location is defined as a fourth position. In the fourth location, the image sensor 34 of the wavefront detecting unit 10 performs the fourth sensing of an interference fringe (step 1808). At this time, an interference fringe 54 sensed by the image sensor 34 has a low-order spherical aberration, as shown in FIG. 5D, and is different from the interference fringe 52 for an on-axis wavefront aberration.

The computing unit 20 calculates a pupil-center coordinate (origin coordinate) to compute the off-axis wavefront aberration of the projection optical system 11 (step 1810). A coma aberration is generated in response to a change in the object distance for an off-axis wavefront aberration. In view of this, unlike an on-axis wavefront aberration, the pupil-center coordinate (origin coordinate) is determined in the following way. That is, an origin coordinate used in computing the wavefront aberration (for example, a Zernike coefficient) is changed, and the amount of change in the coma aberration in response to a change in the object distance is calculated at each of a plurality of origin coordinates. A precise origin coordinate can be determined by detecting an origin coordinate at which the calculated amount of change is equal to the amount of change in the coma aberration from the viewpoint of design of the projection optical system 11. The origin coordinate for an on-axis wavefront aberration is determined by calculating an origin coordinate at which a change in the coma aberration in response to a change in the object distance is minimum. In contrast to this, the origin coordinate for an off-axis wavefront aberration is determined by calculating an origin coordinate at which a change in the comatic aberration is not minimum but closest to a design value.

The above-mentioned process of determining the origin coordinate for an off-axis wavefront aberration is repeated at a plurality of off-axis image points. Because the telecentricity of the projection optical system 11 accounts for a change in the pupil-center coordinate, that process need only be executed at image heights in a number necessary to detect the characteristic of the projection optical system 11. For example, at least three image heights other than those corresponding to on-axis positions need only be measured because the telecentricity can be approximated by:

θ(Y)=A1·Y+A2·Y³+A3·Y⁵

where Y is the image height, and A1, A2, and A3 are constants.

The use of the coefficients A1 to A3 calculated by the above-mentioned equation allows computation of the telecentricity during measurement at an arbitrary image height Y. Computing the wavefront aberration from the wavefront measurement value at the image height Y makes it possible to determine a correct pupil-center coordinate from the calculated value θ(Y). The computing unit 20 computes the wavefront aberration (the wavefront aberration coefficient represented by, for example, a Zernike coefficient) based on the pupil-center coordinate at each image height Y, which is calculated in this way. This allows high-accuracy wavefront aberration measurement.

Once each step in FIG. 17 is executed, the origin coordinate at each image height, which is calculated at this time, can be used in the next measurement. For measurement with a higher accuracy, each step in FIG. 17 need only be executed each time.

Based on the difference between the pupil-center coordinate (X0, Y0) for an on-axis wavefront aberration and the pupil-center coordinate (X1, Y1) for an off-axis wavefront aberration, the computing unit 20 can compute a telecentricity θ for an off-axis wavefront aberration:

θx=sin(ΔX/Xmax·NA)⁻¹(ΔX=X1−X0)

θy=sin(ΔY/Ymax·NA)⁻¹(ΔY=Y1−Y0)

### Second Embodiment

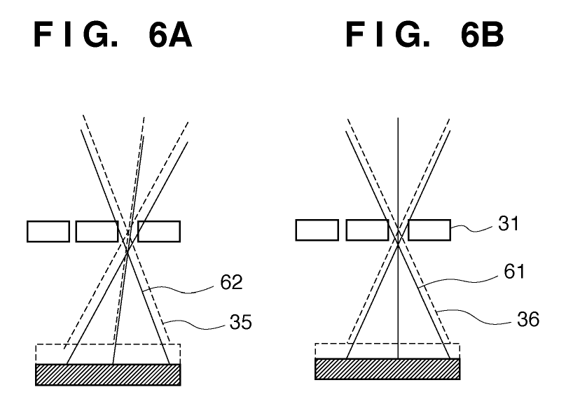

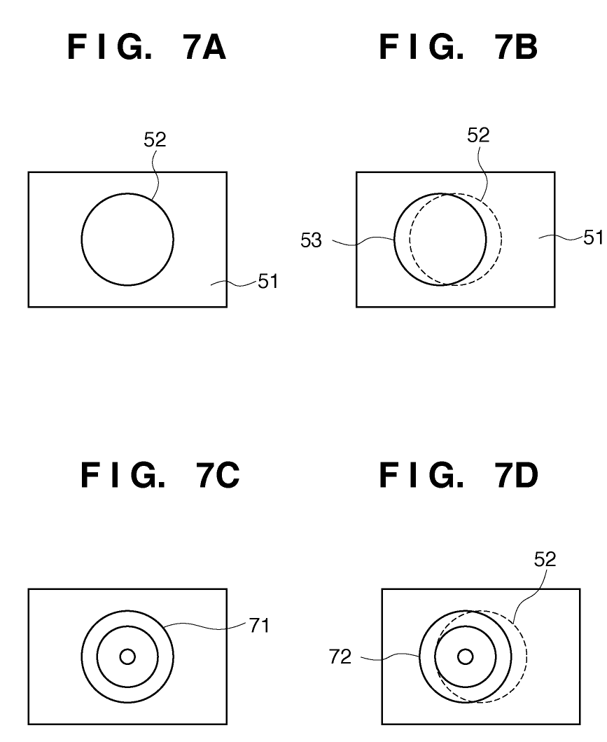

The second embodiment of the present invention will be explained with reference to FIGS. 6A, 6B, and 7A to 7D. Details which are not particularly referred to herein can be the same as in the first embodiment.

The second embodiment is the same as the first embodiment except that a wavefront detecting unit 10 on the image side alone is moved while the object position is fixed in steps 1802 and 1807 of the processing (FIG. 17) in the first embodiment.

The first embodiment uses a change in the spherical aberration in response to a change in the object distance, while the second embodiment uses a change in the power upon defocusing.

FIG. 6B is a view showing the state in which the wavefront detecting unit 10 is located at an on-axis position. First, an interference fringe as illustrated in FIG. 7A is sensed as the first sensing while a second reference wavefront generating optical system 31 is located on a wafer plane 6 (step 1801). In addition, a wafer stage 8 is moved in the optical axis direction to move the movable wavefront detecting unit 10 in the optical axis direction (although this operation corresponds to step 1802, the wavefront detecting unit 10 on the image side alone is moved). An interference fringe as illustrated in FIG. 7C is sensed as the second sensing (step 1803). Referring to FIG. 6B, reference numeral 61 denotes a test light beam which enters the wavefront detecting unit 10 located at an on-axis defocus position.

A computing unit 20 determines an origin coordinate (pupil-center coordinate) to compute the on-axis wavefront aberration (step 1805). This sequence is the same as in the first embodiment. However, the first embodiment uses the fact that the difference between two wavefront aberrations is a spherical aberration, but the second embodiment uses the fact that the difference between two wavefront aberrations is a power component. In other words, the second embodiment uses the fact that a power component is detected as a tilt component if the origin coordinate has an error. The same logic as in the first embodiment applies to the second embodiment when the amount of change ΔW and the characteristic shown in FIG. 15 in the first embodiment are represented by a quadratic function (power component) in place of a quartic function (spherical aberration). In other words, a center coordinate used in computing the wavefront aberration (for example, a Zernike coefficient) is changed, and the amount of change in the tilt in response to a change in the defocus is calculated at each of a plurality of origin coordinates. A precise center coordinate can be determined by detecting an origin coordinate at which the calculated amount of change is minimum.

The wafer stage 8 is driven so that the wavefront detecting unit 10 returns to the focus position in the first measurement and further moves to a desired off-axis position as illustrated in FIG. 6A. At this position, an interference fringe as illustrated in FIG. 7B is sensed as the third sensing (step 1806). An interference fringe 53 is decentered from an interference fringe 52 for an on-axis wavefront aberration. This results from a small amount of deviation of the telecentricity of a projection optical system 11 on its wafer side. In addition, the projection optical system 11 moves the wavefront detecting unit 10 in the optical axis direction (although this operation corresponds to step 1807, the wavefront detecting unit 10 on the image side alone is moved). An interference fringe 72 as illustrated in FIG. 7D is sensed as the fourth sensing (step 1808). Referring to FIG. 6A, reference numeral 62 denotes a test light beam which enters the wavefront detecting unit 10 located at an on-axis defocus position. The interference fringe 72 obtained has a so-called power component at the same position as that in the interference fringe 53 obtained upon the third measurement.

Note that the difference between the wavefront aberrations measured upon the third and fourth sensing must be accounted for solely by the defocus component (power component). In view of this, a center coordinate used in computing the wavefront aberration (for example, a Zernike coefficient) is changed, and the amount of change in the tilt in response to a change in the defocus (power) at each of a plurality of center coordinates is calculated. A precise center coordinate for an off-axis wavefront aberration can be determined by detecting a center coordinate at which the calculated amount of change is minimum, like an on-axis wavefront aberration (step 1810).

After that, the above-mentioned two types of measurements (at the focus and defocus positions) are repeated at desired off-axis positions, as in the first embodiment. This makes it possible to precisely determine a center coordinate used in wavefront aberration computation at an on-axis position and an arbitrary off-axis position. This allows high-accuracy wavefront aberration measurement. Also as in the first embodiment, it is possible to calculate the telecentricity from a difference in pupil-center coordinate between an on-axis position and an arbitrary off-axis position.

In the second embodiment which uses a change in the power, if the telecentricity on the wafer side is poor, the focal point shifts in a direction perpendicular to the optical axis along with defocusing, so a tilt component is generated in the interference fringe. Even in this case, it is possible to compute the telecentricity from the tilt component of the wavefront aberration measurement value upon defocusing, using the pupil-center coordinate determined according to the first embodiment.

### Third Embodiment

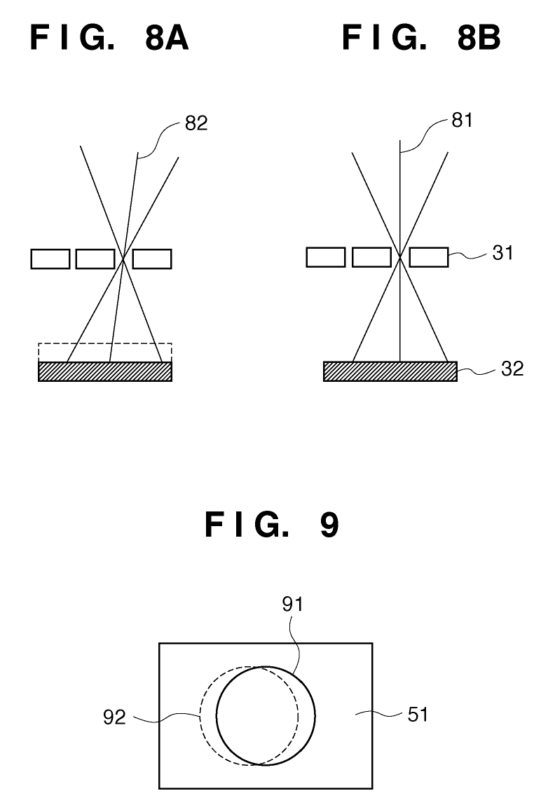

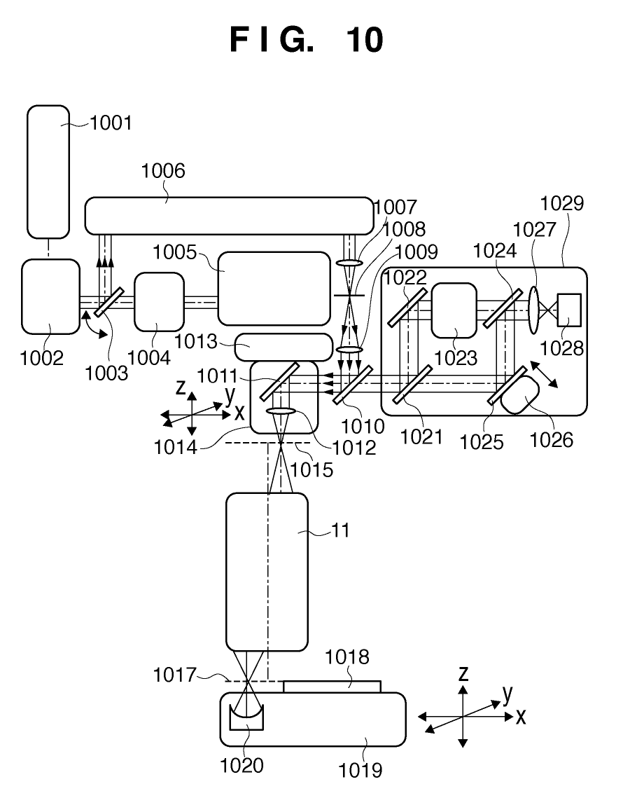

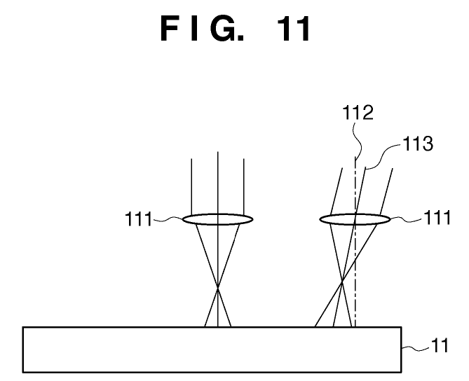

The third embodiment will be explained with reference to FIGS. 8A, 8B, and 9. A wafer stage 8 is moved to locate a wavefront detecting unit 10 at an on-axis focus position. FIG. 8B shows this state. In this state, an image sensor 34 senses a light intensity distribution 91 formed by a light beam 81 transmitted through a window in a second reference wavefront generating optical system 31. The contour of the sensed light intensity distribution 91 is obtained, and the center coordinate of the light intensity distribution 91 is calculated based on the obtained contour. Then, the wavefront detecting unit 10 is moved to a desired off-axis position. At this position as well, the image sensor 34 senses a light intensity distribution 92 formed by a light beam 82 transmitted through the window in the second reference wavefront generating optical system 31. The contour of the sensed light intensity distribution 92 is obtained, and the center coordinate of the light intensity distribution 92 is calculated based on the obtained contour. Calculating the difference between the center coordinates of the light intensity distributions calculated in this way makes it possible to calculate the telecentricity of a projection optical system 11.

### Fourth Embodiment

The fourth embodiment will be explained with reference to FIG. 10. The first embodiment exemplifies a case in which the detection is performed on the wafer side using a single-pass interferometer, while the fourth embodiment exemplifies a case in which the detection is performed on the reticle side using a double-path interferometer.

Although a radial shearing interferometer is provided in the fourth embodiment, the type of interferometer is not particularly limited to this. In exposure, a light beam from a light source 1001 propagates through a beam shaping optical system 1002, incoherent unit 1004, and illumination optical system 1005. In measuring the aberration of a projection optical system 11, an optical path switching mirror 1003 is operated so that a light beam from the light source 1001 propagates through a dedicated light extension system 1006. The light beam having propagated through the dedicated light extension system 1006 converges on a reticle plane 1015 via a collimator lens 1007, spatial filter 1008, collimator lens 1009, half mirror 1010, reflecting mirror 1011, collimator lens 1012, and collimator unit 1014. The reflecting mirror 1011, collimator lens 1012, and collimator unit 1014 are moved by an X-Y-Z stage 1013. The projection optical system 11 is reciprocated via a spherical mirror 1020 on a wafer stage 1019 to guide the light beam to a radial shearing interferometer unit 1029, and wavefront measurement is performed. The radial shearing interferometer unit 1029 includes a half mirror 1021, reflecting mirror 1022, beam expander 1023, half mirror 1024, reflecting mirror 1025, PZT element 1026, imaging lens 1027, and image sensor 1028. Details of this arrangement are described in Japanese Patent Laid-Open No. 2000-277412 (U.S. Pat. No. 6,614,535).

FIG. 11 is an enlarged view of the vicinity of the reticle plane 1015. FIG. 11 shows the state in which a light beam used in interferometric measurement for on- and off-axis wavefront aberrations is in the return path. A light beam 113 on a return trip to the collimator lens 1012 is tilted with respect to a normal 112 to the reticle plane for an off-axis wavefront aberration. This is because it is difficult to perfectly correct the telecentricity of the projection optical system 11 on its reticle side.

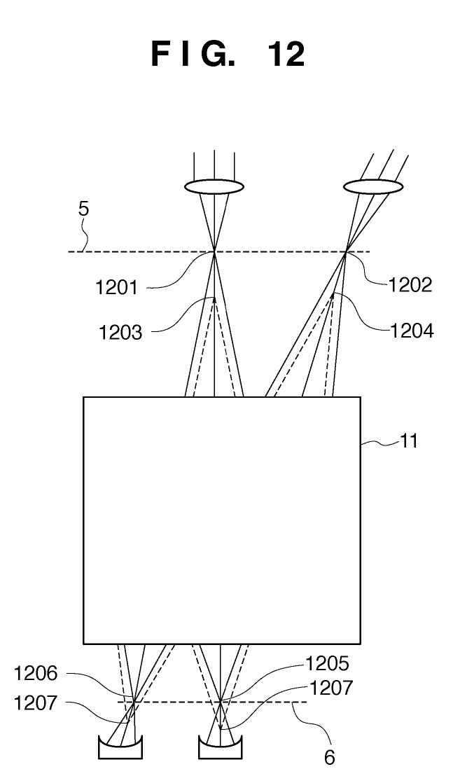

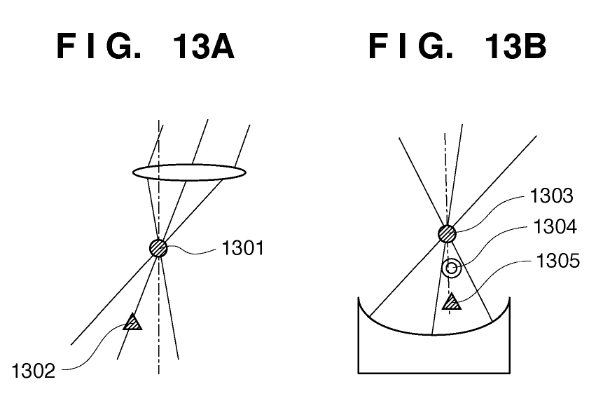

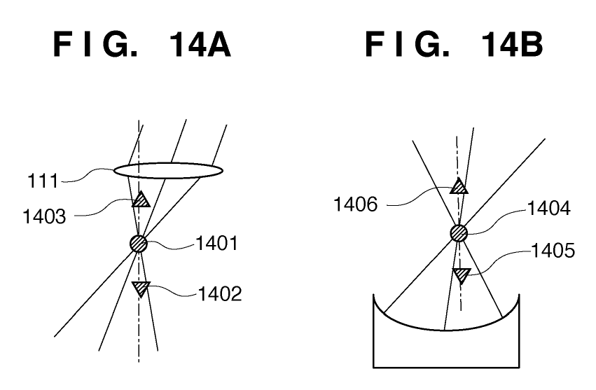

The explanation will be continued with reference to FIG. 12. In the fourth embodiment, the pupil-center coordinates for on- and off-axis wavefront aberrations are precisely determined using a change in the aberration of the projection optical system 11 in response to a change in the object distance, as in the first embodiment. This makes it possible to accurately measure both the wavefront aberration and telecentricity by a reticle-side incidence double-path interferometer. A first wavefront aberration and a second wavefront aberration are measured for an on-axis wavefront aberration, as in the first embodiment. Moving a TS lens on a reticle stage in the optical axis direction makes it possible to measure the wavefront aberrations at different object distances. FIG. 12 shows the relationship between the object point and the image point during four measurements. During the first measurement, a first movable element and second movable element are located at an object point 1201 and image point 1205, respectively. During the second measurement, the first movable element and second movable element are located at an object point 1203 and image point 1207, respectively. During the third measurement, the first movable element and second movable element are located at an object point 1202 and image point 1206, respectively. During the fourth measurement, the first movable element and second movable element are located at an object point 1204 and image point 1208, respectively. A sequence of calculating the center coordinate from each measurement result is the same as in the first embodiment.

### Fifth Embodiment

The fifth embodiment of the present invention will be explained with reference to FIGS. 13A and 13B. The first embodiment uses a change in the power component upon defocusing, instead of using a change in the spherical aberration in response to a change in the object distance in the fourth embodiment. The first and second measurements are performed for an on-axis wavefront aberration as in the first embodiment, and a center coordinate at which a change in the tilt in response to a change between two wavefront aberrations is minimum is calculated. The third measurement is performed at a desired off-axis position. During the third measurement, the center of curvature of the reflecting sphere is aligned with an object point 1301 and its conjugate point 1303 shown in FIG. 13A. Then, a wafer stage is moved to defocus the center of curvature of the reflecting sphere to a position 1304, and the fourth wavefront aberration measurement is performed. The incident point 1303 is imaged at a reflection point 1305 again by the reflecting sphere. Consequently, a projection optical system 11 converges the light at a position 1302, which is defocused and laterally shifted from the object point 1301 upon incidence, on its reticle side. The wavefront aberration measured in this state is also decentered from the result obtained for an on-axis wavefront aberration, as in the first embodiment. This is because the telecentricity of the projection optical system on its reticle side is imperfect. The telecentricity on the reticle side is poorer than that on the wafer side, so the amount of decentering of the pupil center is relatively large in that case. To calculate the pupil-center coordinate from the third and fourth wavefront aberration measurement results, the same sequence as in the second embodiment need only be performed.

### Sixth Embodiment

The sixth embodiment will be explained with reference to FIGS. 14A and 14B. In the sixth embodiment, a TS lens 111 located on the reticle side is moved in the optical axis direction. The third and fourth measurements for an off-axis wavefront aberration will be explained. The wavefront aberration is measured while a focal point 1401 of the TS lens 111 is aligned with the reticle plane. In this state, the light beam forms an image on the wafer plane again by a projection optical system, and the center of curvature 1404 of a spherical mirror matches the wafer plane. Then, the TS lens 111 is moved in the optical axis direction to move the focal point 1401 to a position 1402. The light beam having propagated through the projection optical system forms an image at a position 1405, shown in FIG. 14B, again. After being reflected by the spherical mirror, the light beam forms an image at a position 1406 again. After traveling backward through the projection optical system, the light beam converges at a position 1403, shown in FIG. 14A, near the reticle plane again. The fourth measurement is performed in this state. In the fourth measurement, only the power component has changed from that in the third measurement because the measurement light is defocused on the reticle plane. It is therefore possible to determine the pupil-center coordinate in the same way as in the second and fifth embodiments.

In the methods according to the fifth and sixth embodiments which use a change in the power, if the telecentricity on the reticle side is poor, the focal point shifts in a direction perpendicular to the optical axis along with defocusing, so a tilt component is generated in the interference fringe. Even in this case, it is possible to compute the telecentricity from the tilt component of the wavefront aberration measurement value upon defocusing, using the pupil-center coordinate determined according to the fourth embodiment.

### Seventh Embodiment

It is also possible to calculate the telecentricity of a projection optical system from a change in the distortion calculated by measuring the position of a wavefront detecting unit, at which a one-color interference fringe is formed upon changing the object distance or moving the wavefront detecting unit in the optical axis direction, in place of the pupil-center coordinate.

### Eighth Embodiment

Embodiments of a wavefront aberration measuring device mounted on an exposure apparatus have been described above. Lastly, a wavefront aberration evaluation apparatus used in a process of manufacturing a projection optical system 11 will be exemplified as the eighth embodiment. The wavefront aberration evaluation apparatus can be a known apparatus. For example, it is possible to use a wavefront aberration evaluation apparatus which can measure the wavefront aberration at an arbitrary image height in the field of the projection optical system 11 by a combination of a Fizeau interferometer and an X-Y-Z three-axis stage. Both high-accuracy wavefront measurement and telecentricity measurement can be attained by applying the pupil-center coordinate determination methods and telecentricity measurement methods according to the first to sixth embodiments to the wavefront aberration evaluation apparatus. Using the wavefront aberration and telecentricity measurement results, a projection optical system is assembled/adjusted.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-052581, filed Mar. 3, 2008, which is hereby incorporated by reference herein in its entirety.

What is claimed is:

1. An evaluation method of evaluating an optical characteristic of an optical system to be evaluated using an interferometer, the method comprising:
a first acquisition step of acquiring a first interference fringe formed by the interferometer when a location of a movable element of the interferometer in an optical axis direction of the optical system is a first location;
a second acquisition step of acquiring a second interference fringe formed by the interferometer when the location of the movable element in the optical axis direction is a second location different from the first location;
a determination step of determining a pupil-center coordinate of the optical system based on the acquired first interference fringe and the acquired second interference fringe; and
a computation step of computing the optical characteristic of the optical system using the pupil-center coordinate determined in the determination step.

2. The method according to claim 1, wherein in the determination step, a first wavefront aberration and a second wavefront aberration are computed based on the first interference fringe and the second interference fringe, respectively, while changing a pupil-center coordinate used to compute a wavefront aberration of the optical system, and a pupil-center coordinate at which an amount of change in a difference between the first wavefront aberration and the second wavefront aberration with respect to an amount of change in the pupil-center coordinate is a predetermined amount of change is determined as the pupil-center coordinate used in the computation step.

3. The method according to claim 2, wherein the wavefront aberration of the optical system computed in the determination step includes a coma aberration.

4. The method according to claim 2, wherein the difference between the first wavefront aberration and the second wavefront aberration appears as a spherical aberration.

5. The method according to claim 2, wherein the difference between the first wavefront aberration and the second wavefront aberration appears as a tilt component.

6. The method according to claim 1, wherein the first acquisition step and the second acquisition step are performed by adjusting the interferometer to be able to evaluate an on-axis wavefront aberration and off-axis wavefront aberration of the optical system.

7. The method according to claim 1, wherein in the computation step, a wavefront aberration of the optical system is computed.

8. The method according to claim 1, wherein that in the computation step, a telecentricity of the optical system is computed.

9. An evaluation apparatus which evaluates an optical characteristic of an optical system to be evaluated using an interferometer, the apparatus comprising:
an image sensor which senses an interference fringe formed by the interferometer; and
a computing unit which computes the optical characteristic of the optical system based on the image of the interference fringe provided by said image sensor,
wherein said computing unit determines a pupil-center coordinate of the optical system based on an image obtained by sensing by said image sensor a first interference fringe formed by the interferometer when a location of a movable element of the interferometer in an optical axis direction of the optical system is a first location, and an image obtained by sensing by said image sensor a second interference fringe formed by the interferometer when the location of the movable element in the optical axis direction is a second location different from the first location, and computes the optical characteristic of the optical system using the determined pupil-center coordinate.

10. An exposure apparatus which projects a pattern of an original onto a substrate by a projection optical system, thereby exposing the substrate, the apparatus comprising
an evaluation apparatus which evaluates an optical characteristic of the projection optical system using an interferometer,
said evaluation apparatus including
an image sensor which senses an interference fringe formed by the interferometer, and
a computing unit which computes the optical characteristic of the projection optical system based on the image of the interference fringe provided by said image sensor,
wherein said computing unit determines a pupil-center coordinate of the projection optical system based on an image obtained by sensing by said image sensor a first interference fringe formed by the interferometer when a location of a movable element of the interferometer in an optical axis direction of the projection optical system is a first location, and an image obtained by sensing by said image sensor a second interference fringe formed by the interferometer when the location of the movable element in the optical axis direction is a second location different from the first location, and computes the optical characteristic of the projection optical system using the determined pupil-center coordinate.
